(19) United States
(12) Patent Application Publication
(10) Pub. No.: US 2011/0136993 A1
(43) Pub. Date: Jun. 9, 2011

(54) PHOSPHORUS-CONTAINING COMPOUNDS AND POLYMERIC COMPOSITIONS COMPRISING SAME

(75) Inventors: Anteneh Z Worku, Pearland, TX (US); Ashwin R. Bharadwaj, Pearland, TX (US); Raymond J. Thibault, Shrewsbury, MA (US); Mark B. Wilson, Clute, TX (US); Douglas L. Potts, Clute, TX (US)

(73) Assignee: Dow Global Technologies LLC, Midland, MI (US)

(21) Appl. No.: 13/056,467

(22) PCT Filed: Aug. 26, 2009
(86) PCT No.: PCT/US09/54992

§ 371 Date: Jan. 28, 2011

Related U.S. Application Data
(60) Provisional application No. 61/092,566, filed on Aug. 28, 2008.

(51) Int. Cl. C08G 79/04; C07F 9/6574

(52) U.S. Cl. 525/523; 558/77; 558/83; 528/167; 528/72; 528/168

(57) ABSTRACT

Phosphorus-containing compounds of formula (I): (I) wherein m, n, R, R₁ and R₂ are as set forth in the claims. The compounds of formula (I) can be used to provide polymers with flame retardant properties.

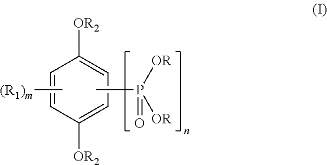

### BACKGROUND OF THE INVENTION

1. Field of the Invention

The present invention relates generally to phosphorus-containing compounds and flame-retardant polymeric compositions which comprise one or more of these compounds, as such and/or covalently bonded to a polymer.

2. Discussion of Background Information

Polymeric compositions with flame-retardant properties are typically made by either physically blending a flame-retardant additive with the polymeric composition or by incorporating a flame-retardant agent into the polymer by covalently bonding it to the polymer skeleton. For example, in the case of epoxy resins incorporation of a flame-retardant compound can be accomplished by incorporating a compound such as, e.g., tetrabromobispenol A into the backbone of the epoxy resin or by using a flame-retardant compound for the cross-linking (curing) of the epoxy resin.

### SUMMARY OF THE INVENTION

The present inventors have now found a class of flame-retardant phosphorus-containing compounds which have a relatively high phosphorus content, can be prepared from readily available and relatively inexpensive starting materials by well-established synthetic procedures and can be incorporated by covalent bonding into not only epoxy resins but also a variety of other polymeric structures and/or can be physically blended with polymeric compositions to endow them with flame-retardant properties.

The present invention provides phosphorus-containing compounds of formula (I):

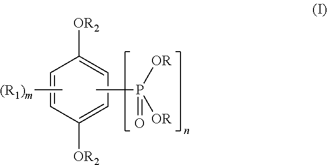

wherein:
m=0, 1, 2, or 3;
n=1, 2, 3 or 4, with the proviso that (m+n) is not higher than 4;
the moieties R₁ are independently selected from optionally substituted alkyl, cycloalkyl, alkenyl, cycloalkenyl, aryl, aralkyl, and alkaryl groups, —NO₂, —OR₂, —COR₃, —CN, halogen, and —N(R₅)₂, and two moieties R₁ on adjacent carbon atoms, together with the carbon atoms to which they are bonded, may form an optionally unsaturated, optionally substituted 5- to 8-membered ring;
the moieties R₂ are independently selected from H, optionally substituted alkyl, cycloalkyl, alkenyl, cycloalkenyl, aryl, aralkyl, and alkaryl groups, glycidyl, —COR₃, and —CN;
the moieties R₃ are independently selected from H, optionally substituted alkyl, cycloalkyl, alkenyl, cycloalkenyl, aryl, aralkyl, and alkaryl groups, —OH, —OR₄, and —N(R₅)₂;
the moieties R₄ are independently selected from optionally substituted alkyl, cycloalkyl, alkenyl, cycloalkenyl, aryl, aralkyl, and alkaryl groups;
the moieties R₅ are independently selected from H and optionally substituted alkyl, cycloalkyl, alkenyl, cycloalkenyl, aryl, aralkyl, and alkaryl groups;
the moieties R are independently selected from H, optionally substituted alkyl, cycloalkyl, alkenyl, cycloalkenyl, aryl, aralkyl, and alkaryl groups, and two moieties R together may form a divalent group of formula —(CR^{a}R^{b})ₚ— wherein p=2, 3, 4, or 5 and R^{a} and R^{b} are independently selected from H and optionally substituted alkyl groups, and at least one of the moieties

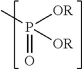

in formula (I) may represent a moiety of formula (II):

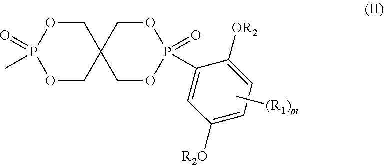

wherein m, R₁ and R₂ have the meanings sets forth above and wherein additionally one of the moieties R₁ may represent a moiety of formula (II).

In one aspect, the compounds of the present invention may be compounds of formula (I) wherein

m=0, 1, or 2;
n=1 or 2;
the moieties R₁ are independently selected from optionally substituted alkyl and alkenyl groups, and —OR₂, and two moieties R₁ on adjacent carbon atoms, together with the carbon atoms to which they are bonded, may form an optionally substituted 6-membered aromatic ring;
the moieties R₂ are independently selected from H, optionally substituted alkyl and alkenyl groups, glycidyl, —COR₃, and —CN; the moieties R₃ are independently selected from optionally substituted alkyl and alkenyl groups; and
the moieties R are independently selected from optionally substituted alkyl groups, and two moieties R together may form a divalent group of formula —(CR^{a}R^{b})ₚ— wherein p=2 or 3 and R^{a} and R^{b} are independently selected from H and optionally substituted alkyl groups, and at least one of the moieties

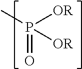

may represent a moiety of formula (II) wherein m, R₁ and R₂ have the meanings set forth above.

In another aspect, the compounds of the present invention may be compounds of formula (I) wherein

m=0 or 1;
n=1 or 2;
the moieties R₁ are independently selected from optionally substituted alkyl groups;
the moieties R₂ are independently selected from H, optionally substituted alkyl and alkenyl groups, glycidyl, —COR₃, and —CN;
the moieties R₃ are independently selected from optionally substituted alkyl and alkenyl groups; and
the moieties R are independently selected from optionally substituted alkyl groups, and two moieties R together may form a divalent group of formula —(CR^{a}R^{b})ₚ— wherein p=2 or 3 and R^{a} and R^{b} are independently selected from H and optionally substituted alkyl groups, and at least one of the moieties

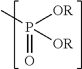

may represent a moiety of formula (II) wherein m, R₁ and R₂ have the meanings set forth above.

In yet another aspect, the compounds of the present invention may be compounds of formula (I) wherein

m=0;
n=1 or 2;
the moieties R₂ are independently selected from H, optionally substituted alkyl and alkenyl groups, glycidyl, —COR₃, and —CN;
the moieties R₃ are independently selected from optionally substituted alkyl and alkenyl groups; and
two moieties R together form a divalent group of formula —(CR^{a}R^{b})ₚ— wherein p=2 or 3 and R^{a} and R^{b} are independently selected from H and optionally substituted alkyl groups; and at least one of the moieties

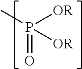

may represent a moiety of formula (II) wherein m, R₁ and R₂ have the meanings set forth above.

In a still further aspect, the compounds of the present invention may be compounds of formula (I) wherein

m=0;
n=1 or 2;
the moieties R₂ are independently selected from H, optionally substituted alkenyl groups, glycidyl, —COR₃, and —CN;
the moieties R₃ are independently selected from optionally substituted alkenyl groups; and
two moieties R together form a divalent group of formula —(CR^{a}R^{b})ₚ— wherein p=3 and R^{a} and R^{b} are independently selected from H and optionally substituted alkyl groups, and at least one of the moieties

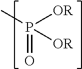

may represent a moiety of formula (II) wherein m, R₁ and R₂ have the meanings set forth above.

In another aspect, the compounds of the present invention may comprise at least about 10% by weight of phosphorus, e.g., at least about 12% by weight of phosphorus, based on the total weight of the compounds.

In another aspect, the compounds of the present invention may be compounds of formula (III), (IV), or (V):

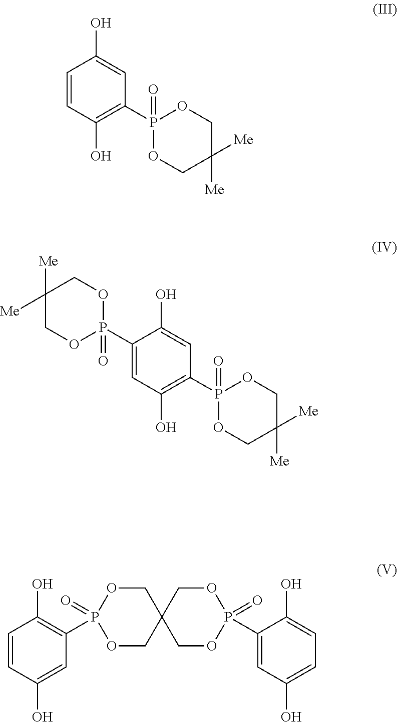

wherein Me represents methyl. In one aspect, in at least some of the hydroxy groups of a compound of formula (III), (IV), or (V) the hydrogen atom may be replaced by a group which is selected from glycidyl, —CN, groups of formula —CO—CR^{c}═CHR^{d}, and groups of formula —CH₂—CR^{c}═CHR^{d}, with R^{c} and R^{d} being independently selected from H and C₁₋₄ alkyl groups.

The present invention also provides methods of preparation for the compounds of formula (III), (IV), or (V), using intermediates i.e., compounds of formulae (VI) and (VII):

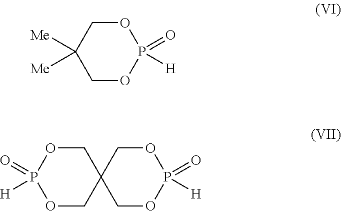

The present invention also provides flame retardant polymers or oligomers which comprise covalently bonded units of at least one compound of the present invention as set forth above (including the various aspects thereof).

The present invention also provides an epoxy resin which has been pre-reacted with a compound of the present invention as set forth above (including the various aspects thereof), which compound comprises at least two groups which are capable of reacting with an epoxy group. For example, the groups which are capable of reacting with an epoxy group may comprise hydroxy groups.

The present invention also provides a curable composition which comprises an epoxy resin and at least one compound of the present invention as set forth above (including the various aspects thereof) and/or an epoxy resin which has been pre-reacted with a compound of the present invention as set forth above.

The present invention also provides a cross-linked epoxy resin which comprises units of a compound of the present invention as set forth above (including the various aspects thereof).

The present invention also provides polymerizable compositions which comprise (i) at least one compound which comprises at least two functional groups, and (ii) at least one compound of the present invention as set forth above (including the various aspects thereof), which compound comprises at least two groups which are capable of reacting with the at least two functional groups of (i), and also provides a flame-retardant polymers which can be prepared from these compositions.

In one aspect, the polymerizable compositions may comprise (i) at least one compound which comprises at least two isocyanate (—NCO) groups, and (ii) at least one compound of the present invention as set forth above (including the various aspects thereof), which compound comprises at least two groups which are capable of reacting with an isocyanate group.

In another aspect, the compositions may comprise (i) at least one compound of the present invention as set forth above (including the various aspects thereof), which compound comprises at least one ethylenically unsaturated moiety, and (ii) at least one compound which comprises at least one ethylenically unsaturated moiety and is different from (i).

In yet another aspect, the compositions may comprise (i) at least one compound of the present invention as set forth above (including the various aspects thereof), which compound comprises at least two cyanate (—OCN) groups, and (ii) at least one compound which comprises at least two groups which are capable of reacting with a cyanate group.

In a still further aspect, the compositions may comprise (i) at least one compound of the present invention as set forth above (including the various aspects thereof), which compound comprises at least two epoxy groups (e.g., in the form of glycidyl groups), and (ii) at least one compound which comprises at least two groups which are capable of reacting with an epoxy group.

In another aspect, the compositions may comprise (i) at least one compound of the present invention as set forth above (including the various aspects thereof), which compound comprises at least two groups which are capable of forming an ester linkage (—CO—O—) with a complimentary group, and (ii) at least one compound which comprises at least two groups which are capable of forming an ester linkage with a complimentary group and is different from (i).

The present invention also provides a method of improving the flame retardancy of a polymeric composition. The method comprises incorporating into the composition at least one compound of the present invention as set forth above (including the various aspects thereof), as such and/or covalently bonded to/incorporated into the polymer.

In one aspect of this method, the polymer may comprise at least one of an epoxy resin, a polyurethane, a polyester, a polycarbonate, a polyisocyanate, and a polymer prepared from one or more ethylenically unsaturated monomers.

In addition, embodiments disclosed herein relate to preparation and screening of curable compositions useful in electrical laminates and solvent-free processes for the preparation and screening of such compositions.

Other features and advantages of the present invention will be set forth in the description of the present invention that follows, and will be apparent, in part, from the description or may be learned by practice of the present invention. The present invention will be realized and attained by the compositions, products, and methods particularly pointed out in the written description and claims hereof.

### BRIEF DESCRIPTION OF THE DRAWINGS

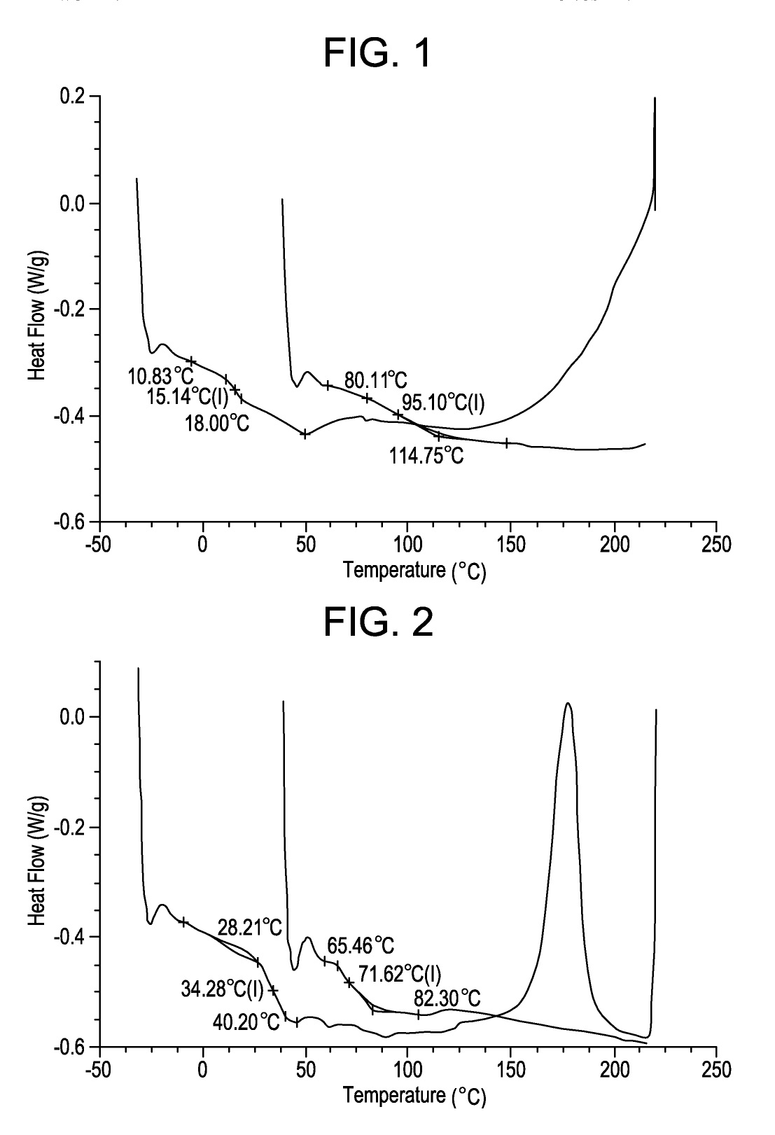

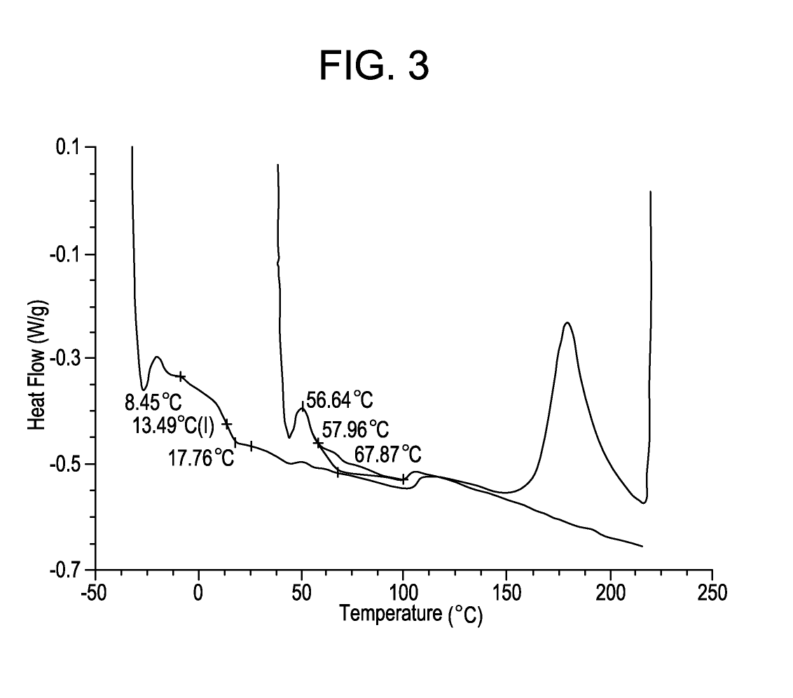

The present invention is further described in the detailed description which follows, in reference to the drawings by way of non-limiting examples of exemplary embodiments of the present invention, wherein FIGS. 1 to 3 are DSC thermograms of an epoxy resin which has been reacted with three compounds of the present invention, i.e., compounds of formulae (III), (IV) and (VII), as described in the Examples below.

### DETAILED DESCRIPTION OF THE PRESENT INVENTION

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show embodiments of the present invention in more detail than is necessary for the fundamental understanding of the present invention, the description making apparent to those skilled in the art how the several forms of the present invention may be embodied in practice.

As set forth above, the present invention provides, inter alia, phosphorus-containing compounds of formula (I):

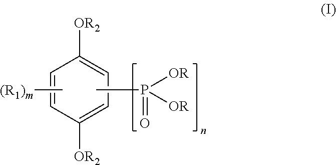

The value of m in the above formula (I) may be 0, 1, 2, or 3, and preferably is 0, 1, or 2. For example, the value of m may be 1, or the value of m may be 0 (i.e., there is only one or no group R₁ present on the benzene ring).

The value of n in the above formula (I) may be 1, 2, 3 or 4 and preferably is 1 or 2. For example, the value of n may be 1. At any rate, the sum (m+n) cannot be higher than 4, and will often not be higher than 3, e.g., not higher than 2.

The moieties R₁ in the above formula (I) are selected from optionally substituted alkyl, cycloalkyl, alkenyl, cycloalkenyl, aryl, aralkyl, and alkaryl groups, —NO₂, —OR₂, —COR₃, —CN, halogen, and —N(R₅)₂. When m=2 or 3, the moieties R₁ may be the same or different, although they are preferably identical. Further, when m=2 or 3, two moieties R₁ on adjacent carbon atoms, together with the carbon atoms to which they are bonded, may form an optionally unsaturated, optionally substituted 5- to 8-membered ring.

Non-limiting examples of optionally substituted alkyl groups as moieties R₁ include linear and branched alkyl groups having from 1 to about 18 carbon atoms, e.g., from 1 to about 12 carbon atoms, from 1 to about 6 carbon atoms, or from 1 to about 4 carbon atoms, such as, e.g., methyl, ethyl, n-propyl, isopropyl, n-butyl, i-butyl, sec.-butyl, tert.-butyl, n-pentyl, n-hexyl, n-heptyl, n-octyl, n-nonyl, n-decyl, n-undecyl, and n-dodecyl. Methyl and ethyl are preferred examples of alkyl groups R₁. Non-limiting examples of the one or more (e.g., 1, 2, 3 or 4) substituents which may optionally be present on these alkyl groups include hydroxy, C₁₋₄ alkoxy (e.g., methoxy or ethoxy), amino (—NH₂), mono(C₁₋₄ alkyl)amino and di(C₁₋₄ alkyl)amino groups, as well as halogen (e.g., F, Cl and Br). If two or more substituents are present, they may be the same or different.

Non-limiting examples of optionally substituted cycloalkyl groups as moieties R₁ include cycloalkyl groups having from about 5 to about 8 carbon atoms, e.g., 5, 6 or 7 carbon atoms, such as, e.g., cyclopentyl and cyclohexyl. Non-limiting examples of the one or more (e.g., 1, 2, 3 or 4) substituents which may optionally be present on these cycloalkyl groups include alkyl (e.g., optionally substituted alkyl groups as set forth above), hydroxy, C₁₋₄ alkoxy (e.g., methoxy or ethoxy), amino, mono(C₁₋₄ alkyl)amino and di(C₁₋₄ alkyl)amino groups, and halogen (e.g., F, Cl and Br). If two or more substituents are present, they may be the same or different.

Non-limiting examples of optionally substituted alkenyl groups as moieties R₁ include linear and branched alkenyl groups having from 2 to about 18 carbon atoms, e.g., from 2 to about 12 carbon atoms, from about 3 to about 6 carbon atoms. These alkenyl groups may comprise one or more ethylenically unsaturated units, e.g., one or two ethylenically unsaturated units. Non-limiting specific examples of alkenyl groups as moieties R₁ include, vinyl, allyl (2-propenyl), 1-propenyl, methallyl and 2-butenyl. Non-limiting examples of the one or more (e.g., 1, 2, 3 or 4) substituents which may optionally be present on these alkenyl groups include hydroxy, C₁₋₄ alkoxy (e.g., methoxy or ethoxy), amino, mono(C₁₋₄ alkyl)amino and di(C₁₋₄ alkyl)amino groups and halogen (e.g., F, Cl and Br). If two or more substituents are present, they may be the same or different.

Non-limiting examples of optionally substituted cycloalkenyl groups as moieties R₁ include cycloalkenyl groups having from about 5 to about 8 carbon atoms, e.g., 5, 6 or 7 carbon atoms, such as, e.g., cyclopentenyl and cyclohexenyl. The cycloalkenyl groups may comprise one or more ethylenically unsaturated units, e.g., one or two ethylenically unsaturated units. Non-limiting examples of the one or more (e.g., 1, 2, 3 or 4) substituents which may optionally be present on these cycloalkenyl groups include alkyl (e.g., the optionally substituted alkyl groups set forth above), alkenyl (e.g., the optionally substituted alkenyl groups set forth above), hydroxy, C₁₋₄ alkoxy (e.g., methoxy or ethoxy), amino, mono(C₁₋₄ alkyl)amino and di(C₁₋₄ alkyl)amino groups halogen (e.g., F, Cl and Br). If two or more substituents are present, they may be the same or different.

Non-limiting examples of aryl groups as moieties R₁ include linear and branched aryl groups having from 6 to about 18 carbon atoms, e.g., from about 6 to about 12 carbon atoms, such as, e.g., phenyl and naphthyl. Non-limiting examples of the one or more (e.g., 1, 2, 3, 4 or 5) substituents which may optionally be present on these aryl groups include halogen (e.g., F, Cl and Br), hydroxy, C₁₋₄ alkoxy (e.g., methoxy or ethoxy), and amino, mono(C₁₋₄ alkyl)amino and di(C₁₋₄ alkyl)amino groups. If two or more substituents are present, they may be the same or different.

Non-limiting examples of optionally substituted aralkyl groups as moieties R₁ include aralkyl groups having from 7 to about 18 carbon atoms, e.g., from 7 to about 12 carbon atoms, such as, e.g., benzyl, phenethyl and naphthylmethyl. Non-limiting examples of the one or more (e.g., 1, 2, 3, 4 or 5) substituents which may optionally be present on these aralkyl groups (on the alkyl part, the aryl part, or both) include hydroxy, C₁₋₄ alkoxy (e.g., methoxy or ethoxy), amino, mono(C₁₋₄ alkyl)amino and di(C₁₋₄ alkyl)amino groups, and halogen (e.g., F, Cl and Br). Further examples of substituents for the aryl part of the aralkyl group include optionally substituted alkyl and alkenyl groups such as, e.g., those set forth above. If two or more substituents are present, they may be the same or different.

Non-limiting examples of alkaryl groups as moieties R₁ include alkaryl groups having from 7 to about 18 carbon atoms, e.g., from 7 to about 12 carbon atoms, such as, e.g., tolyl, xylyl and ethylphenyl. Non-limiting examples of the one or more (e.g., 1, 2, 3, 4 or 5) substituents which may optionally be present on these alkaryl groups (on the alkyl part, the aryl part, or both) include hydroxy, C₁₋₄ alkoxy (e.g., methoxy or ethoxy), and amino, mono(C₁₋₄ alkyl)amino and di(C₁₋₄ alkyl)amino groups, and halogen (e.g., F, Cl and Br). Further examples of substituents for the aryl part of the alkaryl group include optionally substituted alkenyl groups such as, e.g., those set forth above. If two or more substituents are present, they may be the same or different.

If two moieties R₁ are present on adjacent carbon atoms they may form an optionally substituted, saturated or unsaturated 5- to 8 membered ring together with the carbon atoms to which they are bonded. Preferably, the ring is 6-membered and even more preferably aromatic, giving rise to a naphthyl group. The ring formed by two moieties R₁ may optionally be substituted with one or more (e.g., 1, 2, 3 or 4) substituents. Non-limiting examples thereof include alkyl (e.g., the exemplary alkyl groups set forth above), alkenyl (e.g., the exemplary alkenyl groups set forth above), halogen (e.g., F, Cl and Br), hydroxy, C₁₋₄ alkoxy (e.g., methoxy or ethoxy), and amino, mono(C₁₋₄ alkyl)amino, and di(C₁₋₄ alkyl)amino groups. If two or more substituents are present, they may be the same or different.

If a moiety R₁ represents —COR₃ the moiety R₃ may be selected from H, optionally substituted alkyl, cycloalkyl, alkenyl, cycloalkenyl, aryl, aralkyl, and alkaryl groups, —OH, —OR₄, and —N(R₅)₂. Non-limiting examples of optionally substituted alkyl, cycloalkyl, alkenyl, cycloalkenyl, aryl, aralkyl, and alkaryl groups include those which are set forth above with respect to the meanings of R₁. Preferred meanings of R₃ are optionally substituted alkyl (e.g., methyl and ethyl), optionally substituted alkenyl (e.g., vinyl, propen-2-yl, 1-propenyl and 2-propenyl) and —OR₄.

If R₃ represents —OR₄, R₄ may be selected from optionally substituted alkyl, cycloalkyl, alkenyl, cycloalkenyl, aryl, aralkyl, and alkaryl groups. Non-limiting examples of optionally substituted alkyl, cycloalkyl, alkenyl, cycloalkenyl, aryl, aralkyl, and alkaryl groups include those which are set forth above with respect to the meanings of R₁. Preferred meanings of R₄ are optionally substituted alkyl (e.g., methyl and ethyl) and optionally substituted alkenyl (e.g., vinyl, propen-2-yl and 1-propenyl).

If R₃ represents —N(R₅)₂, the moieties R₅ may be the same or different and are selected from H and optionally substituted alkyl, cycloalkyl, alkenyl, cycloalkenyl, aryl, aralkyl, and alkaryl groups. Non-limiting examples of optionally substituted alkyl, cycloalkyl, alkenyl, cycloalkenyl, aryl, aralkyl, and alkaryl groups include those which are set forth above with respect to the meanings of R₁. Preferred meanings of R₅ are H and optionally substituted alkyl (e.g., methyl and ethyl).

If R₁ represents halogen, examples thereof include F, Cl and Br. If two or more halogen atoms are present, they may be the same or different, but are preferably identical. In one embodiment, the one or more moieties R₁, if present at all, are different from a halogen atom, as the compounds of formula (I) are preferably halogen-free.

Preferred moieties R₁, if present, are alkyl, alkenyl, —OR₂, and —COR₃, in particular alkyl and —OR₂.

The moieties R₂ in the above formula (I) are independently selected from H, optionally substituted alkyl, cycloalkyl, alkenyl, cycloalkenyl, aryl, aralkyl, and alkaryl groups, glycidyl, —COR₃, and —CN. Non-limiting examples of optionally substituted alkyl, cycloalkyl, alkenyl, cycloalkenyl, aryl, aralkyl, and alkaryl groups include those which are set forth above with respect to the meanings of R₁. Exemplary and preferred meanings of groups —COR₃ include those which are set forth above with respect to the meanings of R₁. Preferred meanings of the moieties R₂ are H, optionally substituted alkyl, optionally substituted alkenyl, glycidyl, —CN and —COR₃ wherein R₃ represents optionally substituted alkyl or optionally substituted alkenyl. A particularly preferred meaning of R₂ is H. Also, the groups R₂ are preferably identical. In this regard, it is to be appreciated that more than two groups —OR₂ may be present on the benzene ring, i.e., if one or more moieties R₁ are present and at least one moiety R₁ represents —OR₂.

The moieties R in the above formula (I) are selected from H, optionally substituted alkyl, cycloalkyl, alkenyl, cycloalkenyl, aryl, aralkyl, and alkaryl groups. Non-limiting examples of optionally substituted alkyl, cycloalkyl, alkenyl, cycloalkenyl, aryl, aralkyl, and alkaryl groups include those which are set forth above with respect to the meanings of R₁. The moieties R may be the same or different and are preferably identical. Preferred meanings of R are optionally substituted alkyl groups having from 1 to about 4 carbon atoms such as, e.g., methyl, ethyl, n-propyl and isopropyl.

The two moieties R together may further form a divalent group of formula —(CR^{a}R^{b})ₚ— wherein p=2, 3, 4, or 5 and R^{a} and R^{b} are selected from H and optionally substituted alkyl groups. Non-limiting examples of optionally substituted alkyl groups include those which have been set forth above with respect to the meanings of R₁. When present on the same carbon atom, the moieties R^{a} and R^{b} may be the same or different. Also, in each unit —(CR^{a}R^{b})— the meanings of R^{a} and R^{b} may be the same or different from the meanings of R^{a} and R^{b} in another unit —(CR^{a}R^{b})—. Preferred meanings of R^{a} and R^{b} are hydrogen and alkyl groups having from 1 to about 4 carbon atoms such as, e.g., methyl, and ethyl, and in particular methyl. The value of p is preferably 2 or 3, most preferably 3. Also, the number of carbon atoms in the divalent group of formula —(CR^{a}R^{b})ₚ— is preferably not higher than about 8, e.g., not higher than about 7, not higher than about 6, or not higher than about 5. Non-limiting specific examples of units of formula —(CR^{a}R^{b})ₚ— include (—CH₂—)₂, (—CH₂—)₃, (—CH₂—)₄, —CH₂—CH(CH₃)—CH₂—, —CH₂—C(CH₃)₂—CH₂—, —CH₂—CH(C₂H₅)—CH₂—, —CH₂—C(CH₃)(C₂H₅)—CH₂—, and —CH₂—C(C₂H₅)₂—CH₂—.

Further, at least one (and preferably not more than two) of the moieties

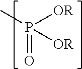

in formula (I) (which moieties may be the same or different if n equals 2, 3 or 4, but preferably are identical) may represent a moiety of formula (II):

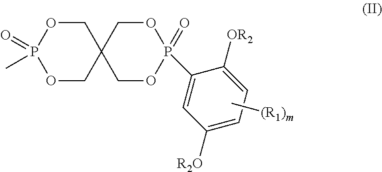

In formula (II) the meanings of m, R₁ and R₂ are the same as the meanings of R₁ and R₂ in formula (I) which are set forth above (including the exemplary and preferred meanings). Additionally, one of the moieties R₁ in formula (II) may represent a moiety of formula (II). In other words, the corresponding compound of formula (I) may be an oligomer (or a mixture of different oligomers) which may comprise, for each moiety of formula (II) present, e.g., a total of up to about 10, e.g., up to about 8, up to about 6, up to about 4, up to about 3, or about 2 moieties of formula (II).

The compounds of formula (I) may be prepared by methods which are well established and well known to those of skill in the art. For example, a compound of formula (I) wherein R₂ represents hydrogen may be prepared by reacting (heating) a mixture of a compound of formula HPO(OR)₂ and an optionally substituted p-benzoquinone in an aprotic organic solvent such as, e.g., toluene in the presence of an inorganic or organic acid such as, e.g., hydrochloric acid, formic acid or acetic acid. Exemplary procedures are illustrated in Examples 2 and 4 below. Compounds of formula HPO(OR)₂ may in turn be prepared by reacting (heating) a trivalent phosphorus compound, e.g., a phosphorus trihalide such as PCl₃ with one or more alcohols (or a diol) in an organic solvent such as toluene. Exemplary procedures are illustrated in Examples 1 and 3 below.

Compounds of formula (I) wherein R₂ represents hydrogen can be converted into a wide variety of other compounds of formula (I), for example, compounds of formula (I) wherein one or both of the moieties R₂ are different from hydrogen. By way of non-limiting example, the phenolic hydroxy groups can be reacted with an epihalohydrin such as epichlorohydrin to afford a compound of formula (I) wherein one or both groups R₂ represent glycidyl.

Further, the phenolic hydroxy groups may be esterified with, e.g., a carboxylic acid, the corresponding carboxylic anhydride or the corresponding carboxylic halide to afford compounds of formula (I) wherein R₂ represents —COR₃. Non-limiting examples of carboxylic acids include formic acid, acetic acid, propionic acid, acrylic acid, methacrylic acid, crotonic acid and maleic acid (in the latter case, two units of formula (I) may be linked by a maleic acid bridge).

Even further, the phenolic hydroxy groups of compounds of formula (I) wherein one or both groups R₂ represent hydrogen may be etherified with an alcohol or a diol or a suitable derivative thereof to prepare compounds of formula (I) wherein one or both moieties R₂ represent an optionally substituted alkyl, cycloalkyl, alkenyl, cycloalkenyl, aryl, aralkyl, or alkaryl group.

By way of non-limiting example, the allylation of a (bis)phenol of formula (I) may be accomplished via a transcarbonation reaction using, for example, allyl methyl carbonate or a direct allylation reaction using, for example, an allyl halide, a methallyl halide and the like plus an alkaline agent and optional catalyst such as a phase transfer catalyst. Allyl methyl carbonate is usually prepared from the reaction of allyl alcohol and dimethyl carbonate to give a mixture of allyl methyl carbonate and diallyl carbonate. Both the crude mixture and the pure allyl methyl carbonate can be used as the allylating agent as well as allyl halides such as allyl chloride, allyl bromide, methallyl chloride, methallyl bromide, and the like.

A preferred process uses a transcarbonation reaction wherein allyl methyl carbonate is stoichiometrically reacted with a bisphenol of formula (I) and provides essentially total allylation of the hydroxy groups of the bisphenol to provide the corresponding allylether (allyloxy) groups. In the direct allylation reaction, an allyl halide may be stoichiometrically reacted with the hydroxy groups of the bisphenol. Depending on reaction conditions, variable amounts of Claisen rearrangement product may be observed in this reaction, resulting in mixtures of O- and C-allylated products.

A direct allylation reaction of a (bis)phenol of formula (I) with an allyl halide such as allyl chloride may, for example, be conducted in the presence of an alkaline agent such as an aqueous solution of an alkali metal hydroxide (e.g., NaOH). If desired, inert solvents such as, e.g., 1,4-dioxane and phase transfer catalysts such as, e.g., benzyltrialkylammonium halides or tetraalkylammonium halides can be employed. Reaction temperatures of from about 25° C. to about 150° C. are operable with temperatures of from about 50° C. to about 100° C. being preferred.

Compounds of formula (I) wherein one or both of the moieties R₂ represent hydrogen can further be converted into cyanate compounds, e.g., compounds of formula (I) wherein one or both of the moieties R₂ represent —CN. For example, cyanates of formula (I) may be prepared by reaction of a (bis)phenol of formula (I) with a cyanogen halide. By way of non-limiting example, the (di)cyanate compounds may be prepared by reacting a bisphenol of formula (I) with an about stoichiometric quantity or a slight stoichiometric excess (up to about 20 percent excess) of a cyanogen halide per phenolic hydroxyl group in the presence of an about stoichiometric quantity or a slight stoichiometric excess (up to about 20 percent excess) of a base compound per phenolic hydroxy group and in the presence of a suitable solvent. Usually reaction temperatures of from about −40° C. to about 60° C. are employed, with reaction temperatures of from about −15° C. to about 10° C. being preferred and reaction temperatures of from about −10° C. to about 0° C. being particularly preferred. Non-limiting examples of suitable cyanogen halides include cyanogen chloride and cyanogen bromide. Alternately, the method described in Organic Synthesis, volume 61, pages 35-68 (1983), published by John Wiley and Sons, the entire disclosure of which is expressly incorporated by reference herein, can be used to generate the cyanogen halide in situ from sodium cyanide and a halogen such as chlorine or bromine Non-limiting examples of suitable base compounds for use in the above process include both inorganic bases and tertiary amines such as sodium hydroxide, potassium hydroxide, trimethylamine, triethylamine, and mixtures thereof. Triethylamine is most preferred as the base. Non-limiting examples of suitable solvents for the cyanation reaction include water, aliphatic ketones, chlorinated hydrocarbons, aliphatic and cycloaliphatic ethers and diethers, aromatic hydrocarbons, and mixtures thereof. Acetone, methylethylketone, methylene chloride, and chloroform are particularly suitable as the solvent.

Of course, the possible reactions of compounds of formula (I) are not limited to the conversion of the phenolic hydroxy groups OR₂ wherein R₂ represents hydrogen. Moieties R₂ which are different from hydrogen may be converted into other moieties R₂ as well. Additionally or alternatively, the aromatic ring may be substituted to afford compounds of formula (I) wherein m is different from 0. Further, moieties R₁ which are present after the substitution reaction may be converted into desired moieties R₁. For example, if a moiety R₁ represents a hydroxy group, the hydroxy group may, for example, be converted by the same procedures as those which have been set forth above with respect to the moieties OR₂. Also, one or more moieties R₁ may already be present on the p-benzoquinone (or other) starting material. For example, an optionally substituted 1,4-naphthoquinone or a substituted p-benzoquinone may be used as a starting material instead of the unsubstituted p-benzoquinone.

The compounds of formula (I) can be used to impart flame retardancy to a variety of organic polymers in a number of ways. For example, compounds of formula (I) can be incorporated in the main chain or side chain of an organic polymer and/or can be used as crosslinking agent for an organic polymer. Moreover, they can also be added as such to (physically blended with) polymeric compositions, i.e., function as a flame-retardant additive. Of course, they can also be employed both as a flame retardant additive and incorporated into the structure of an optionally cross-linked organic polymer. In this regard, it is pointed out that the term “polymer” as used herein and in the appended claims is intended to include all types of polymeric and oligomeric substances regardless of their degree of polymerization and the way in which they have been produced (e.g., by free radical polymerization, cationic polymerization, anionic polymerization, polycondensation, etc.).

The amount of compound(s) of formula (I) that is advantageously employed depends on a number of factors such as, e.g., the phosphorus content of the compound(s) of formula (I) (the compounds of formula (I) preferably have a phosphorus content of at least about 10%, e.g., at least about 11%, at least about 12%, at least about 13%, at least about 14%, or even at least about 15% by weight, based on the total weight of the compound), and the degree of flame retardancy that is to be imparted to a polymeric composition and the product made therefrom. For example, a UL 94 V-0 rating (Underwriter Laboratories) is typically achieved with phosphorus contents of from about 1% to about 5% by weight, based on the total weight of organic solids present.

If compounds of formula (I) are to be incorporated into a polymer by covalent bonding they may be used as one of the monomeric starting materials which are used for the preparation of the polymer. By way of non-limiting example, if a flame-retardant polyurethane, polyester or polycarbonate is to be produced a compound of formula (I) wherein R₂ represents hydrogen may be used as at least a part of the diol and/or polyol starting materials. If a polymer of an ethylenically unsaturated compound is to be produced (for example a polyolefin such as, e.g., polyethylene and polypropylene, or a styrene homo- or copolymer such as, e.g., polystyrene, high impact polystyrene (HIPS), ABS or SAN), a compound of formula (I) wherein R₂ represents an alkenyl group such as, e.g., allyl or methallyl and/or a compound of formula (I) wherein R₂ represents —COR₃ wherein R₃ represents an alkenyl group such as, e.g., vinyl or propen-2-yl may form a part of the monomeric starting materials. Of course, blends of different polymers such as, e.g., polycarbonate/ABS or polypropylene oxide/HIPS may also be rendered flame-retardant in this manner. Also, compounds of formula (I) wherein one or more of the moieties R₁ comprise functional groups which are suitable for taking part in a polymerization reaction may be used as well.

Polymers and polymeric compositions which comprise units which are derived from compounds of formula (I) may be used for all applications for which corresponding polymers without units of compounds of formula (I) may be used, for example, for the production of (molded) articles, fibers, foams, coatings, etc. and also in the field of electronics and semiconductors, e.g., for the production of electrical laminate boards (particularly in the case of epoxy resins).

In the case of epoxy resins the compounds of formula (I) may be used as at least a part of the epoxy resin (e.g., if R₂ in formula (I) represents glycidyl) and/or as at least a part of the cross-linking agent for the epoxy resin (e.g., if R₂ in formula (I) represents hydrogen and/or if the compound of formula (I) comprises at least two functional groups which are capable of reacting with an epoxy group such as, e.g., groups selected from acid groups, amino groups, acid anhydride groups, phosphate and phosphinate, which groups may be present, for example, as (or as a part of) the moieties R₁ and/or R₂). Compounds of formula (I) will often be used as cross-linking agents for epoxy resins, preferably in combination with one or more additional cross-linking agents (e.g., those which are known to be suitable for the cross-linking of epoxy resins such as, e.g., dicyandiamide, substituted guanidines, phenolic compounds, amino compounds, benzoxazine, carboxylic anhydrides, amido amines, and polymamides). In this regard, it is to be appreciated that compounds of formula (I) may be employed as cross-linking agent as such and/or in pre-reacted form, e.g., pre-reacted with an epoxy resin. (This also applies to compounds of formula (I) which are employed for the production of other polymers such as, e.g., polyurethanes, polyesters etc.).

Non-limiting examples of epoxy resins for which the compounds of formula (I) may serve as cross-linking agent include di- or poly-functional epoxy resins, and combinations thereof. Polymeric epoxy resins may be aliphatic, cycloaliphatic, aromatic, or heterocyclic epoxy resins. The polymeric epoxy resins include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxy resins may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidated resins, cycloaliphatic resins, epoxidized oils, and so forth. The glycidated resins are frequently the reaction product of epichlorohydrin and a bisphenol compound, such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane.

In some embodiments, the epoxy resin may include glycidyl ether type; glycidyl-ester type; alicyclic type; heterocyclic type, etc. Non-limiting examples of suitable epoxy resins include cresol novolac epoxy resin, phenolic novolac epoxy resin, biphenyl epoxy resin, hydroquinone epoxy resin, stilbene epoxy resin, and mixtures and combinations thereof.

Non-limiting examples of epoxy resins which can be cross-linked by compounds of the present invention also include glycidyl derivatives of one or more of: aromatic diamines, aromatic monoprimary amines, aminophenols, polyhydric phenols, polyhydric alcohols, and polycarboxylic acids such as, e.g., resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidylether of Bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more epoxy resins, polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate.

Still further examples of epoxy resins which may be cross-linked by compounds of formula (I) according to the present invention include polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxycyclohexyl)propane; polyglycidyl ethers of aliphatic and aromatic polycarboxylic acids, such as, for example, oxalic acid, succinic acid, glutaric acid, terephthalic acid, 2,6-naphthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy naphthalene; modified epoxy resins with acrylate or urethane moieties; glycidylamine epoxy resins; and novolac resins.

Still other examples of epoxy resins which may be cross-linked by compounds of the present invention include copolymers of acrylic acid esters of glycidol such as glycidylacrylate and glycidylmethacrylate with one or more copolymerizable vinyl compounds. Examples of such copolymers are styrene/glycidylmethacrylate, methylmethacrylate/glycidylacrylate and methylmethacrylate/ethylacrylate/-glycidylmethacrylate.

Epoxy resins that are readily available include diglycidyl ether of bisphenol A;

D.E.R. 331, D.E.R.332 and D.E.R. 334 from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl)adipate; bis(2,3-epoxycyclopentyl)ether; aliphatic epoxy modified with polypropylene glycol; dipentene dioxide; epoxidized polybutadiene; silicone resin containing epoxy functionality; 1,4-butanediol diglycidyl ether of phenol-formaldehyde novolac (such as those available under the tradenames D.E.N. 431 and D.E.N. 438 available from The Dow Chemical Company); and resorcinol diglycidyl ether. Although not specifically mentioned, other epoxy resins under the tradename designations D.E.R. and D.E.N. available from the Dow Chemical Company are also useful for the purposes of the present invention.

Further examples of epoxy resins which may be cross-linked with compounds of formula (I) of the present invention are disclosed in, for example, U.S. Pat. Nos. 7,163,973, 6,887,574, 6,632,893, 6,242,083, 7,037,958, 6,572,971, 6,153,719, and 5,405,688, WO 2006/052727, and U.S. Patent Application Publication Nos. 2006/0293172 and 2005/0171237, the entire disclosures of which are incorporated by reference herein.

In order to obtain satisfactory flame retardancy the concentration of phosphorus in the epoxy (or any other) resin composition often will be from about 0.2% to about 3.5%, e.g., from about 1% to about 3%, or from about 1.5% to about 2.8% by weight, based on the total weight of the organic solids in the resin composition.

Compounds which may be used in combination with one or more compounds of formula (I) and/or pre-reacted forms thereof for the cross-linking of epoxy resins include all compounds which are known for this purpose. Usually, these compounds comprise at least two functional groups which are reactive with an epoxy group such as, e.g., phenolic groups, acid groups, amino groups, and acid anhydride groups. These compounds may also have been pre-reacted with epoxy resins.

The curable epoxy resin compositions of the present invention may contain one or more catalysts which are capable of promoting the reaction between the cross-linking agent(s) and the epoxy resin and for promoting the curing of the epoxy resin.

Non-limiting examples of suitable catalyst materials include compounds containing amine, phosphine, ammonium, phosphonium, arsonium or sulfonium moieties. Particularly preferred catalysts are heterocyclic nitrogen-containing compounds.

The catalysts preferably contain on average no more than about 1 active hydrogen moiety per molecule. Examples of active hydrogen moieties include hydrogen atoms bonded to an amine group, a phenolic hydroxyl group, a carboxylic acid group, a thiol group, an amide group, a urethane group, and a carbonate group, to name but a few. For instance, the amine and phosphine moieties in catalysts are preferably tertiary amine or phosphine moieties; and the ammonium and phosphonium moieties are preferably quaternary ammonium and phosphonium moieties.

Among preferred tertiary amines that may be used as catalysts are mono- or polyamines with an open-chain or cyclic structure which have all of the amine hydrogens replaced by suitable substituents, such as hydrocarbyl groups, and preferably aliphatic, cycloaliphatic or aromatic groups.

Non-limiting examples of these amines include, among others, 1,8-diazabicyclo(5.4.0)undec-7-ene (DBU), methyl diethanolamine, triethylamine, tributylamine, dimethyl benzylamine, triphenylamine, tricyclohexyl amine, pyridine and quinoline. Preferred amines are the trialkyl, tricycloalkyl and triaryl amines, such as triethylamine, triphenylamine, tri-(2,3-dimethylcyclohexyl)amine, and the alkyl dialkanol amines, such as methyl diethanol amines and the trialkanolamines such as triethanolamine Weak tertiary amines, for example, amines which in a 1 M aqueous solution afford a pH of less than 10, are particularly preferred. Especially preferred tertiary amine catalysts are benzyldimethylamine and tris(dimethylaminomethyl)phenol.

Non-limiting examples of suitable heterocyclic nitrogen-containing catalysts include those described in U.S. Pat. No. 4,925,901, the entire disclosure of which is incorporated by reference herein. Preferable heterocyclic secondary and tertiary amines or nitrogen-containing catalysts which can be employed include, for example, imidazoles, benzimidazoles, imidazolidines, imidazolines, oxazoles, pyrroles, thiazoles, pyridines, pyrazines, morpholines, pyridazines, pyrimidines, pyrrolidines, pyrazoles, quinoxalines, quinazolines, phthalozines, quinolines, purines, indazoles, indoles, indolazines, phenazines, phenarsazines, phenothiazines, pyrrolines, indolines, piperidines, piperazines and combinations thereof. Especially preferred are alkyl-substituted imidazoles; 2,5-chloro-4-ethyl imidazole; and phenyl-substituted imidazoles, and mixtures thereof. Even more preferred are N-methylimidazole; 2-methylimidazole; 2-ethyl-4-methylimidazole; 1,2-dimethylimidazole; and 2-methylimidazole.

Further non-limiting examples of catalysts for use in the present invention include hydrazides, modified ureas, and “latent catalysts” such as, e.g., Ancamine 2441, K61B (modified aliphatic amines available from Air Products), and Ajinomoto PN-23 or MY-24.

A Lewis acid may also optionally be employed in the curable epoxy resin compositions of the present invention, especially when the catalyst is a heterocyclic nitrogen-containing compound. Examples of heterocyclic nitrogen-containing catalysts, which are preferably used in combination with Lewis acids are those described in EP-A 526488, EP-A 0458502, and GB-A 9421405.3, the entire disclosures of which are incorporated by reference herein. Lewis acids which are useful include, for example, halides, oxides, hydroxides and alkoxides of zinc, tin, titanium, cobalt, manganese, iron, silicon, aluminum, and boron, for example Lewis acids of boron, and anhydrides of Lewis acids of boron, for example boric acid, metaboric acid, optionally substituted boroxines (such as trimethoxyboroxine), optionally substituted oxides of boron, alkyl borates, boron halides, zinc halides (such as zinc chloride) and other Lewis acids that tend to have a relatively weak conjugate base. Preferably the Lewis acid is a Lewis acid of boron, or an anhydride of a Lewis acid of boron, for example boric acid, metaboric acid, an optionally substituted boroxine (such as trimethoxy boroxine, trimethyl boroxine or triethyl boroxine), an optionally substituted oxide of boron, or an alkyl borate. These Lewis acids are very effective in curing epoxy resins when combined with the heterocyclic nitrogen-containing compounds set forth above.

The amount of the Lewis acid employed is preferably at least about 0.1 moles of Lewis acid per mole of heterocyclic nitrogen compound, more preferably at least about 0.3 moles of Lewis acid per mole of heterocyclic nitrogen-containing compound. The Lewis acid preferably is present in amounts which are not higher than about 5 moles per mole of catalyst, e.g., not higher than about 4 moles, or not higher than about 3 moles of Lewis acid per mole of catalyst. The total amount of the catalyst usually is from about 0.1% to about 3%, e.g., from about 0.1% to about 2% by weight, based on the total weight of the organic solids of the composition.

The compositions of the present invention may also optionally contain one or more additional flame retardant additives, including for example, liquid or solid phosphorus-containing compounds such as, e.g., polyphosphates, polyphosphonates, phosphites, phosphazenes, compounds which contain phosphorus in the side chain such as, e.g., dioctyl phthalate—epoxy reaction products, and adducts of DOPO (6H-dibenz[c,e][1,2]oxaphosphorin-6-oxide); nitrogen-containing fire retardants and/or synergists, for example melamine, substituted melamine, cyanuric acid, isocyanuric acid and derivatives thereof; halogenated flame retardants and halogenated epoxy resins (especially brominated epoxy resins); synergistic phosphorus-halogen containing chemicals; compounds containing salts of organic acids; inorganic metal hydrates such as, aluminum hydrate and magnesium hydrate; boron-containing compounds such as, e.g., zinc borate; antimony-containing compounds such as, e.g., Sb₂O₃ and Sb₂O₅; metallocenes; and combinations thereof.

When additional flame retardants which contain phosphorus are present in a composition of the present invention, the phosphorus-containing flame retardants are generally present in amounts such that the total phosphorus content of the resin composition is from about 0.2% to about 5% by weight, based on the total weight of the organic solids.

Also, optionally, other non-flame retardant additives such as inorganic fillers (e.g., talc) may be used in the compositions of the present invention.

The epoxy resin compositions (and also other polymer compositions) of the present invention may also optionally contain one or more other additives including, for example, pigments, colorants, UV stabilizers, blowing agents, nucleating agents, synergists, antioxidants, plastizicers, lubricants, wetting and dispersing aids, flow modifiers, surface modifiers, adhesion promoters, mold release agents, solvents, fillers, glass fibers, solvents, reactive and non-reactive thermoplastic resins, etc.

When a solvent is used in the epoxy (or other) resin compositions of the present invention (for example, for improving processability) it may include for example, propylene glycolmethylether (Dowanol PM™, available from The Dow Chemical Company), methoxypropylacetate (Dowanol PMA™, available from The Dow Chemical Company), methylethylketone (MEK), acetone, methanol, and combinations thereof.

Non-limiting examples of fillers for use in the present invention include functional and non-functional particulate fillers with a particle size range of from about 0.5 nm to about 100 μm. Specific examples thereof include silica, alumina trihydrate, aluminum oxide, metal oxides, carbon nanotubes, carbon black, and graphite.

Non-limiting examples of adhesion promoters for use in the present invention include modified organosilanes (epoxidized, methacryl, amino, allyl, etc.), acetylacetonates, sulfur containing molecules, titanates, and zirconates.

Non-limiting examples of wetting and dispersing aids for use in the present invention include modified organosilanes such as, e.g., Byk 900 series and W 9010, and modified fluorocarbons.

Non-limiting examples of surface modifiers for use in the present invention include slip and gloss additives, a number of which are available from Byk-Chemie, Germany.

Non-limiting examples of thermoplastic resins for use in the epoxy resin compositions of the present invention include reactive and non-reactive thermoplastic resins such as, e.g., polyphenylsulfones, polysulfones, polyethersulfones, polyvinylidene fluoride, polyetherimides, polyphthalimides, polybenzimidazoles, acrylics, phenoxy resins, and polyurethanes.

Non-limiting examples of mold release agents for use in the present invention include waxes such as, e.g., carnauba wax.

Of course, the resin compositions of the present invention may comprise various other optional additives. For example, they may comprise functional additives or pre-reacted products to improve polymer properties. Non-limiting examples thereof include (e.g., for epoxy resins) bismaleimides, triazines, isocyanates, isocyanurates, cyanate esters, allyl group containing molecules, etc.

The compositions of the present invention can be produced by mixing all the components together in any order.

Embodiments disclosed herein also relate to the formation of compositions by grinding and admixing the components of the compositions, including at least one thermosetting monomer, at a temperature below a melting temperature of at least a majority of the components, by weight, to form the composition. “Majority,” as used herein, refers to greater than 50% of the total weight of the composition. In various embodiments, grinding and admixing may be performed at a temperature below a melting temperature of at least 60%, at least 70%, at least 80%, at least 90%, or at least 95%, or even 100% of the composition, by weight. Where some components are used at a temperature above their melting temperatures, such components may coat, adsorb, or otherwise be incorporated into the particles formed by the grinding.

Admixing and grinding may be performed at a temperature, for example, of less than about 25° C. In some embodiments, the grinding and admixing may be performed at a temperature in the range from about −273° C. to about 0° C.; from about −200° C. to about 0° C. in other embodiments; and from about −80° C. to about 0° C. in yet other embodiments.

Grinding and admixing components in this manner may result in an admixture of components in the form of particles. Due to the grinding and admixing at a temperature less than the melting temperature of the components, particles formed due to the grinding process may be heterogeneous in composition. In other words, the particles formed may not have a similar composition, including an admixture of each of the various components of the composition, as would be formed using a solvent-borne process or a melt-extrusion process. Even though some of the components may have a high melting temperature and may be viscous on melting, it has been found that adequate mixing of the components occurs during the curing process, allowing the formation of the full network structure. Full curing, for example, has been observed for such compositions as determined by comparison of glass transition temperatures for compositions made according to embodiments disclosed herein with those formed by solvent-borne processes.

Compositions and their resulting thermoset resins may be screened by forming curable compositions according to embodiments disclosed herein, as described above and including grinding and admixing components of the curable composition at a temperature below a melting temperature of at least a majority of the components, by weight.

Processes disclosed herein may be used to readily incorporate components, including those that are poorly soluble in solvents used in conventional solvent-borne processes, into curable compositions.

The compositions of the present invention can be used, for example, to make composite materials by techniques well known in the industry such as by pultrusion, molding, encapsulation, or coating. Especially the epoxy resin compositions of the present invention are particularly useful for making B-staged prepregs and laminates by well known techniques in the industry.

The polymerizable or curable compositions of the present invention may be used for any application that such resin compositions are used. For example, the epoxy resin compositions may be useful as adhesives, sealants, structural and electrical laminates, coatings, castings, structures for the aerospace industry, as circuit boards and the like for the electronics industry. The compositions disclosed herein may also be used in electrical varnishes, encapsulants, semiconductors, general molding powders, filament wound pipe, storage tanks, liners for pumps, and corrosion resistant coatings, among others.

In some embodiments, the curable epoxy resin compositions described herein may be cured as such. In other embodiments, composites may be formed by applying a curable epoxy resin composition to a reinforcing material, such as by impregnating or coating the reinforcing material, and then curing the curable epoxy resin composition with the reinforcing material.

Especially when used for the cross-linking of epoxy resins, the compounds of the present invention may be used, inter alia, as flame-retardancy imparting compounds for the production of printed circuit boards and materials for integrated circuit packaging (such as IC substrates).

### Example 1

### Synthesis of Starting Material Formula (VII)

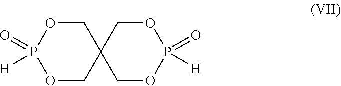

In a 500 mL flask, 1,2-dichlorobenzene (100 mL) was added to pentaerythritol (54.5 g, 400 mmol) and pyridine hydrochloride (0.1 g, 1 mmol). Phosphorous trichloride (PCl₃, 109.9 g, 800 mmol, 69 mL) was added dropwise over 1 hour via an addition funnel. The resultant solution was heated to 100° C. over a period of 2 h and maintained at 100° C. for one additional hour, resulting in a clear, colorless solution containing the intermediate 3,9-dichloro-2,4,8,10-tetraoxa-3,9-diphosphaspiro[5.5]undecane which was confirmed by ³¹P NMR (122 MHz, DMSO, −149 ppm). Formic acid (36.8 g, 800 mmol) was added dropwise to the solution over 65 min. The temperature was maintained at 25° C. to 42° C. during the addition. Nitrogen was bubbled through the solution to remove HCl and CO. The reaction mixture was filtered via vacuum filtration to collect the solids. The solids were washed with toluene and diethyl ether, affording 3,9-H-3,9-dioxa-2,4,8,10-tetraoxa-3,9-diphosphaspiro[5.5]undecane as a white solid (81.1 g, 89%). ³¹P NMR (122 MHz, DMSO): −6.4 ppm. ESI/LC/MS: Actual for C₅H₁₀O₄P₂: 228.08. Found: 228.08

### Example 2

### Preparation of Oligomeric Version of Compound of Formula (V)

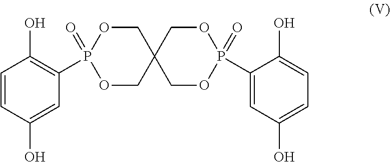

In a 250 mL three neck flask, 3,9-H-3,9-dioxa-2,4,8,10-tetraoxa-3,9-diphosphaspiro[5.5]undecane (6.00 g, 26.3 mmol) was added to 2-ethoxyethanol (100 mL) and thereafter p-benzoquinone (5.67 g, 52.6 mmol) was added and the resultant mixture was heated to 125° C. for approximately 5 hours. Over the course of the reaction the reaction mixture solidified. The solid formed in the reaction mixture was dried in a vacuum oven overnight and an oligomeric version of the compound of formula (V) was isolated. ³¹P NMR (121 MHz, DMSO,) δ −7.46, −7.26, −7.12, −7.02

### Example 3

### Synthesis of Phosphonate Starting Material of Formula VI

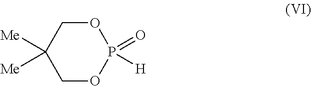

Into a 250 mL 5-neck flask containing 70 mL of toluene, neopentyl glycol (41.7 g, 0.4 mol) and water (0.40 mol) were added under vigorous stirring. Phosphorus trichloride (PCl₃, 54.9 g, 0.40 mol) was added dropwise and the reaction mixture was warmed to 35° C. The temperature was maintained at 50° C. once the initial exotherm had subsided. The cloudy mixture turned clear, whereafter the mixture was heated at 110° C. for 3 hours. The reaction can be monitored by ³¹P NMR. Nitrogen flow can be increased at this time to sweep away the residual HCl. After the reaction was complete, the resultant mixture was transferred to a flask and concentrated in vacuo to remove toluene. The slurry of white solid was further dried in a vacuum oven to afford neopentyl glycol hydrogen phosphonate (59.3 g, 99%). Melting point: 51-53° C.; ¹H NMR (300 MHz, CDCl₃) δ 8.05 (d, 1H), 7.09 (m, 4H), 4.11 (m, 8H), 1.12 (s, 3H), 1.03 (s, 3H); ³¹P NMR (121.348 MHz, CDCl₃) δ 4.08.

### Example 4

### Preparation of Compounds of Formulae (III) and (IV)

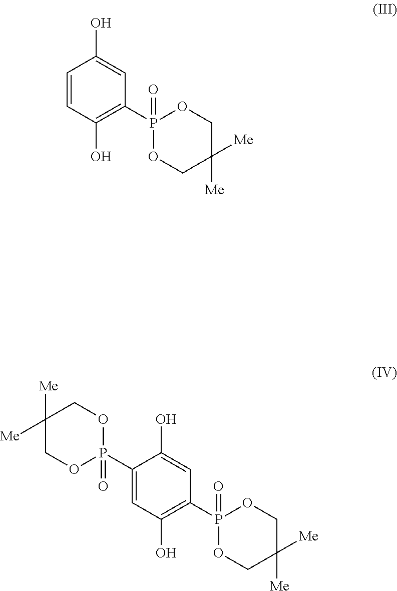

In a 5-neck 500 mL round bottom flask fitted with a mechanical stirrer and reflux condenser, neopentylglycol hydrogen phosphonate (30 g, 200 mmol) was added to toluene (500 mL). To this solution p-benzoquinone (21.6 g, 200 mmol) and acetic acid (1.2 g, 20 mmol) in toluene (20 mL) were added dropwise over minutes. The resultant solution was heated to 110° C. and the reaction was monitored by ³¹P NMR. Upon completion of the reaction as determined by ³¹P NMR the mixture was cooled to ambient temperature upon which a brown solid precipitated. The solid was a mixture of compounds of formula (III) and (IV). The brown solid was stirred in methyl ethyl ketone (900 mL). The solid was recollected and the compound of formula (IV) (5.3 g, 6%) was isolated. The filtrate was removed under reduced pressure to obtain a tan solid which was further stirred in diethyl ether (500 mL). The solid was collected via vacuum filtration and the compound of formula (III) (33.4 g, 64%) was isolated.

### Compound of Formula (III):

¹H NMR (300 MHz, DMSO) δ: 9.65 (1H, s), 9.10 (1H, s), 6.95-9.70 (3H, m), 4.10-3.90 (4H, m), 1.14 (3H, s), 0.95 (3H, s);

³¹P NMR (121 MHz, DMSO) δ: 13.1;

ESI/LC/MS: Actual for C₁₁H₁₅O₅P: 258.07. Found 258.07.

### Compound of Formula (IV):

¹H NMR (300 MHz, DMSO) δ: 9.86 (2H, s), 7.08 (2H, s), 3.74 (4H, m), 3.54 (4H, m), 1.17 (6H, s), 0.61 (6H, s);

¹³C NMR (122 MHz, DMSO) δ: 158.5, 154.6, 123.9, 77.3, 31.9, 22.3, 20.4;

³¹P NMR (121 MHz, DMSO,) δ: 9.6;

ESI/LC/MS: Actual for C₁₆H₂₄O₈P₂: 406.10. Found 406.09.

### Example 5

### Reactivity Test of Compounds of Formulae (VII), (III) and (IV)

A DSC method was developed to check for the reactivity of the compounds of formulae (IV), (V) and (VI) with epoxy resin. The small scale reaction and screening procedure was as follows:

D.E.N.™ 438 (an epoxy novolac resin having an epoxy equivalent weight of 180 from The Dow Chemical Company) is placed in a convection oven at 60° C.-100° C. until the viscosity of the resin is reduced. A total of 3.5-3.8 g of D.E.N.™ 438 is weighed into an aluminum weigh pan. The test compound is weighed separately (about 1.10 g) and added gently to the aluminum pan at 170° C. The reaction mixture is stirred for 5 minutes at this temperature with a wooden tongue depressor. The aluminum pan is then removed from the hot plate and allowed to cool for approximately 2 minutes. The pan is placed back on the hot plate and a solution of ethyltriphenylphosphonium acetate (A-1 catalyst) in methanol is added and the resin mixture is heated with stirring for 5 minutes. Generally the reactive residue will be clear and on occasion pieces of reactive that do not dissolve will be observed. Upon cooling, the aluminum pan is placed in a plastic bag and sealed. The modified resin, a glassy solid at room temperature, is then analyzed by DSC (Differential Scanning calorimetry) using the following protocol:

Equilibrate at −50° C.

Ramp 10° C./min to 220° C.

Isotherm for 30 minutes at 220° C.

Equilibrate at −40° C.

Ramp 10° C./min to 220° C.

FIGS. 1, 2 and 3 show the DSC curves obtained, in the given order, with the compounds of formula (VII), formula (III), and formula (IV). The DSC data indicates advancement with all of the test compounds based on the increased Tg versus that of neat D.E.N.™ 438. Additional advancement is observed during the DSC analysis which is evidenced by the difference in the Tg before and after the 220° C. isotherm. The A1 catalyst was chosen to minimize homopolymerization of the epoxy resin, therefore, the increase in Tg is attributed to a reaction between the epoxy resin and the test compound.

### Example 6

### Sample Preparation

All of the components listed in Table 1 were added to a polycarbonate sample tube. The sample was then placed into in Spex SamplePrep 6870 Freezer Mill. The sample vial was pre-cooled for 15 minutes in a bath of liquid nitrogen and pulverized for 3 cycles at 2 minutes each at 10 cps. Once complete, the sample vial was removed from the chamber and warmed up to ambient temperature and isolated. The powder can be finely ground by mortar and pestle for further use.

TABLE 1
Components

| Formulation Components | Amounts |
|---|---|
| DER ™ 6508 | 19.18 |
| DEN ™ 438 | 14.39 |
| ReziCure ® 3026 | 2.6 |
| Durite ® 357-D | 0.89 |
| NP-42 | 13 |
| 2-Methyl Imidazole | 0.17 |
| Boric Acid | 0.15 |

### Prepreg Preparation

The press was preheated to 125° C. A cut piece of 7628 glass cloth (12″×12″) was placed on a metal release sheet, and below this sheet 2 Tyvex® spacers were placed. A 5.2 gram quantity of sifted cryoground powder was added to the glass sheet. The powder was leveled out to make a circle by use of a tongue depressor. Then, a second release sheet was added with two more Tyvex® spacers. A second metal sheet was placed on top and the material was placed into the press at the desired temperature. The press was closed with a force of 22.2 kilonewtons for 110 seconds. After the time has elapsed, the cycle was stopped and the material removed from the press. The material was cooled to below its Tg, for approximately 2 minutes. The metal sheet, release sheet, and spacers are then removed.

### Preparation of Laminate

The laminate was prepared using the following process: First, the prepreg samples are cut to the desired size and the prepreg sheets are stapled together. An uncoated aluminum sheet is then placed down on a caul plate. The prepreg stack is then placed in between two release sheets and another uncoated aluminum sheet is placed on top.

The program for the preparation of the laminate was as follows:

Step 1: −13.3 C/min to 142.8 C with 55.2 kPa for a 10 second hold

Step 2: −13.3 C/min to 192.2 C with 103.4 kPa for a 90 second hold

Step 3: −9.4 C/min to 37.8 C with 103.4 kPa for a 30 second hold

### Flammability Testing

Flammability Testing was performed under the standard ASTM method D 3801 (the UL-94 vertical flammability test). The rating was V-0 at 3.1% P loading. The data is shown in Table 2, below.

TABLE 2
Flammability Testing (3.1% P loading)

| Flammability | T1 (s) | T2 (s) | |
|---|---|---|---|
| | 0.5 | 4.4 | |
| | 0.7 | 5 | |
| | 0.7 | 7.3 | |
| | 0.7 | 1.4 | |
| | 1.4 | 2.9 | |
| Sum | 4 | 21 | |
| Total Time | | 25 | s |

| | |
|---|---|
| Rating | V-0 |

Although the present invention has been described in considerable detail with regard to certain versions thereof, other versions are possible, and alterations, permutations, and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

1. A compound of formula (I): 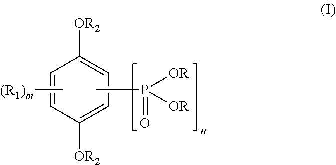
wherein:
m=0, 1, 2, or 3;
n=1, 2, 3 or 4, with the proviso that (m+n) is not higher than 4;
the moieties R₁ are independently selected from optionally substituted alkyl, cycloalkyl, alkenyl, cycloalkenyl, aryl, aralkyl, and alkaryl groups, —NO₂, —OR₂, —COR₃, —CN, halogen, and —N(R₅)₂, and two moieties R₁ on adjacent carbon atoms, together with the carbon atoms to which they are bonded, may form an optionally unsaturated, optionally substituted 5- to 8-membered ring;
the moieties R₂ are independently selected from H, optionally substituted alkyl, cycloalkyl, alkenyl, cycloalkenyl, aryl, aralkyl, and alkaryl groups, glycidyl, —COR₃, and —CN;
the moieties R₃ are independently selected from H, optionally substituted alkyl, cycloalkyl, alkenyl, cycloalkenyl, aryl, aralkyl, and alkaryl groups, —OH, —OR₄, and —N(R₅)₂;
the moieties R₄ are independently selected from optionally substituted alkyl, cycloalkyl, alkenyl, cycloalkenyl, aryl, aralkyl, and alkaryl groups;
the moieties R₅ are independently selected from H and optionally substituted alkyl, cycloalkyl, alkenyl, cycloalkenyl, aryl, aralkyl, and alkaryl groups;
the moieties R are independently selected from H, optionally substituted alkyl, cycloalkyl, alkenyl, cycloalkenyl, aryl, aralkyl, and alkaryl groups, and two moieties R together may form a divalent group of formula —(CR^{a}R^{b})ₚ— wherein p=2, 3, 4, or 5 and R^{a} and R^{b} are independently selected from H and optionally substituted alkyl groups, and at least one of the moieties 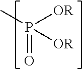
may represent a moiety of formula (II): 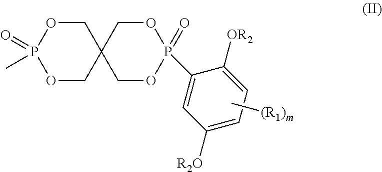
wherein m, R₁ and R₂ have the meanings sets forth above and wherein additionally one of the moieties R₁ may represent a moiety of formula (II).

2. The compound of claim 1, wherein
m=0, 1, or 2;
n=1 or 2;
the moieties R₁ are independently selected from optionally substituted alkyl and alkenyl groups, and —OR₂, and two moieties R₁ on adjacent carbon atoms, together with the carbon atoms to which they are bonded, may form an optionally substituted 6-membered aromatic ring;
the moieties R₂ are independently selected from H, optionally substituted alkyl and alkenyl groups, glycidyl, —COR₃, and —CN;
the moieties R₃ are independently selected from optionally substituted alkyl and alkenyl groups; and
the moieties R are independently selected from optionally substituted alkyl groups, and two moieties R together may form a divalent group of formula —(CR^{a}R^{b})ₚ— wherein p=2 or 3 and R^{a} and R^{b} are independently selected from H and optionally substituted alkyl groups, and at least one of the moieties 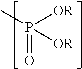
may represent a moiety of formula (II) wherein m, R₁ and R₂ have the meanings set forth above.

3. The compound of claim 1,
wherein
m=0 or 1;
n=1 or 2;
the moieties R₁ are independently selected from optionally substituted alkyl groups;
the moieties R₂ are independently selected from H, optionally substituted alkyl and alkenyl groups, glycidyl, —COR₃, and —CN;
the moieties R₃ are independently selected from optionally substituted alkyl and alkenyl groups; and
the moieties R are independently selected from optionally substituted alkyl groups, and two moieties R together may form a divalent group of formula —(CR^{a}R^{b})ₚ— wherein p=2 or 3 and R^{a} and R^{b} are independently selected from H and optionally substituted alkyl groups, and at least one of the moieties 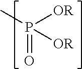
may represent a moiety of formula (II) wherein m, R₁ and R₂ have the meanings set forth above.

4. The compound of claim 1,
wherein
m=0;
n=1 or 2;
the moieties R₂ are independently selected from H, optionally substituted alkyl and alkenyl groups, glycidyl, —COR₃, and —CN;
the moieties R₃ are independently selected from optionally substituted alkyl and alkenyl groups; and
two moieties R together form a divalent group of formula —(CR^{a}R^{b})ₚ— wherein p=2 or 3 and R^{a} and R^{b} are independently selected from H and optionally substituted alkyl groups; and at least one of the moieties 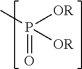
may represent a moiety of formula (II) wherein m, R₁ and R₂ have the meanings set forth above.

5. The compound of claim 1,
wherein
m=0;
n=1 or 2;
the moieties R₂ are independently selected from H, optionally substituted alkenyl groups, glycidyl, —COR₃, and —CN;
the moieties R₃ are independently selected from optionally substituted alkenyl groups; and
two moieties R together form a divalent group of formula —(CR^{a}R^{b})ₚ— wherein p=3 and R^{a} and R^{b} are independently selected from H and optionally substituted alkyl groups, and at least one of the moieties 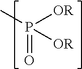
may represent a moiety of formula (II) wherein m, R₁ and R₂ have the meanings set forth above.

6. The compound of claim 1, wherein the compound comprises at least about 10% by weight of phosphorus.

7. (canceled)

8. The compound of claim 1, wherein the compound is of formula (III), (IV), or (V): 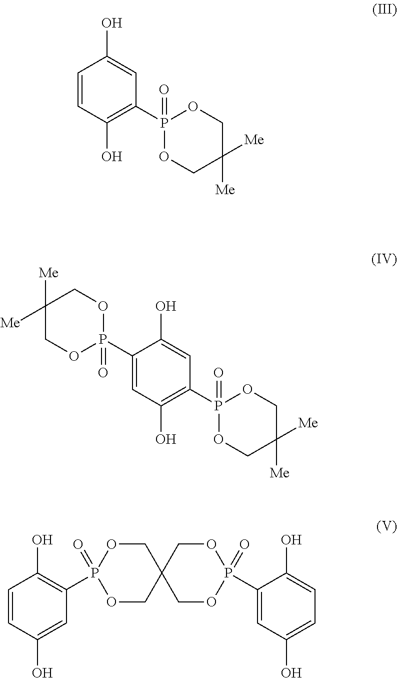
wherein Me represents methyl.

9. The compound of claim 8, wherein in at least some hydroxy groups a hydrogen atom is replaced by a group which is selected from glycidyl, —CN, groups of formula —CO—CR^{c}═CHR^{d}, and groups of formula —CH₂—CR^{c}═CHR^{d}, R^{c} and R^{d} being independently selected from H and C₁₋₄ alkyl groups.

10. A flame retardant polymer or oligomer, wherein the polymer of oligomer comprises covalently bonded units of at least one compound of claim 1.

11. An epoxy resin which has been pre-reacted with a compound of claim 1, comprising at least two groups which are capable of reacting with an epoxy group.

12. (canceled)

13. A curable composition, wherein the composition comprises an epoxy resin and at least one compound of claim 1, the epoxy resin of any one of claims 11 and 12, or a mixture thereof.

14. A cross-linked epoxy resin which comprises units of a compound of claim 1.

15. A polymerizable composition, wherein the composition comprises (i) at least one compound which comprises at least two functional groups, and (ii) at least one compound of claim 1 which comprises at least two groups which are capable of reacting with the at least two functional groups of (i).

16. A flame-retardant polymer prepared from the composition of claim 15.

17. The polymerizable composition of claim 15, wherein the composition comprises (i) at least one compound which comprises at least two isocyanate groups, and (ii) at least one compound of claim 1 which comprises at least two groups which are capable of reacting with an isocyanate group.

18. A flame-retardant polyurethane prepared from the composition of claim 17.

19. The polymerizable composition of claim 15, wherein the composition comprises (i) at least one compound of claim 1 which comprises at least one ethylenically unsaturated moiety, and (ii) at least one compound which comprises at least one ethylenically unsaturated moiety and is different from (i).

20. A flame-retardant polymer prepared from the composition of claim 19.

21. The polymerizable composition of claim 15, wherein the composition comprises (i) at least one compound of claim 1 which comprises at least two cyanate groups, and (ii) at least one compound which comprises at least two groups which are capable of reacting with a cyanate group.

22. A flame-retardant polymer prepared from the composition of claim 21.

23. The polymerizable composition of claim 15, wherein the composition comprises (i) at least one compound of claim 1 which comprises at least two epoxy groups, and (ii) at least one compound which comprises at least two groups which are capable of reacting with an epoxy group.

24. A flame-retardant cured epoxy resin prepared from the composition of claim 23.

25. The polymerizable composition of claim 15, wherein the composition comprises (i) at least one compound of claim 1 which comprises at least two groups which are capable of forming an ester linkage with a complimentary group, and (ii) at least one compound which comprises at least two groups which are capable of forming an ester linkage with a complimentary group and is different from (i).

26. A flame-retardant polyester or polycarbonate prepared from the composition of claim 25.

27. A method of improving the flame retardancy of a polymer composition, wherein the method comprises incorporating into the composition at least one compound of claim 1, as such and/or covalently bonded to the polymer.

28. The method of claim 27, wherein the polymer comprises at least one of an epoxy resin, a polyurethane, a polyester, a polycarbonate, a polyisocyanate, and a polymer prepared from one or more ethylenically unsaturated monomers.
